(19) United States
(12) Patent Application Publication
(10) Pub. No.: US 2007/0091527 A1
(43) Pub. Date: Apr. 26, 2007

(54) Automatic detection of a CMOS circuit device in latch-up and reset of power thereto

(75) Inventor: Joseph Harry Julicher, Chandler, AZ (US)

Correspondence Address: BAKER BOTTS, LLP, 910 LOUISIANA, HOUSTON, TX, 77002-4995, US

(73) Assignee: Microchip Technology Incorporated

(21) Appl. No.: 11/254,269

(22) Filed: Oct. 20, 2005

(51) Int. Cl. H02H 9/02

(52) U.S. Cl. 361/93.1

(57) ABSTRACT

A monitoring and protection circuit associated with a voltage regulator supplying power to a CMOS circuit device can sense over current levels precisely enough for determining if a fault has occurred, e.g., latch-up, failed or shorted transistor, etc., then this monitoring and protection circuit may automatically generate a fault alert signal and/or cycle power to the CMOS circuit device when an unexpected over current may occur, e.g., CMOS circuit latch-up. The monitoring and protection circuit may be integrated with a voltage regulator, e.g., low drop-out (LDO) voltage regulator. The monitoring and protection circuit may be integrated with a CMOS circuit device, e.g., digital processor. The monitoring and protection circuit may be a stand alone device.

### TECHNICAL FIELD

The present disclosure relates to the detection of latch-up of a CMOS circuit device and reset thereof, and more particularly, to automatic detection of the CMOS circuit device in latch-up and reset of power thereto.

### BACKGROUND

Complementary metal oxide semiconductor (CMOS) circuits are used extensively in digital integrated circuit devices, e.g., digital processors and the like. However, CMOS circuits are susceptible to latch-up for a variety of reasons, such as electrical fast transients (EFT), electrostatic discharge (ESD and the like; over-voltage conditions, ionizing radiation, e.g., aerospace and military use, etc. When latch-up occurs in a CMOS circuit there may be unusually high currents drawn which may damage or destroy the CMOS circuit and also possibly the voltage regulator supplying the CMOS circuit. Latch-up of the CMOS circuit may render the circuit inoperative. A way to correct latch-up of a CMOS circuit is to cycle power to it, e.g., off then back on.

### SUMMARY

There is a need for more robust CMOS circuit devices that can withstand or be protected from the various latch-up causing events so that the occurrence of, for example but not limited to, single event upsets (SEU) and/or single event latch-up (SEL) are recoverable. If a monitoring and protection circuit associated with the voltage regulator supplying power to the CMOS circuit device can sense over current levels precisely enough for determining if a fault has occurred, e.g., latch-up, failed or shorted transistor, etc., then this monitoring and protection circuit may automatically generate a fault alert signal and/or cycle power to the CMOS circuit device when an unexpected over current may occur, e.g., CMOS circuit latch-up. The monitoring and protection circuit may be integrated with a voltage regulator, e.g., low drop-out (LDO) voltage regulator. The monitoring and protection circuit may be integrated with a CMOS circuit device, e.g., digital processor. The monitoring and protection circuit may be a stand alone device.

CMOS circuit device operating current requirements (loads) may vary widely during normal operation thereof, and it would be useful for the CMOS circuit device to indicate an expected current requirement (e.g., CMOS circuit device power load) or “state information.” This state information may indicate when it is appropriate to change current limits, and/or disable or enable over current monitoring. The state information from the CMOS circuit device may also be used as a heartbeat for a watchdog timer function when monitoring proper operation of the CMOS circuit device.

For example, a power recycle may be initiated if the protection circuit detected an excessive current (e.g., CMOS latch-up condition) in relation to the expected operating current obtained from the state information. A system reset may be generated if the watchdog timer function failed to respond within a certain time (e.g., CMOS circuit device not operating). The monitoring and protection circuit may also be used as a solid state circuit breaker that may have at least one current trip value, and that at least one current trip value may be programmed during operation of the CMOS circuit device or during system fabrication and/or start-up.

According to a specific example embodiment of this disclosure, an apparatus for monitoring and protection of a CMOS circuit device may comprise: a current measurement circuit having a measured current output; a comparator having a first input coupled to the measured current output of the current measurement circuit; a current trip set point circuit having a current trip set point output coupled to a second input of the comparator; and a power switch controlled by an output of the comparator, wherein the comparator compares the measured current from the current measurement circuit and the current trip set point, whereby when the measured current is greater than the current trip set point the power switch is turned off, and when the measured current is less than or equal to the current trip set point the power switch is turned on. The current trip set point may be programmable The power switch may be adapted for supplying power to a CMOS circuit device and the power switch stays off for a certain time before turning back on. The certain time may be long enough for the CMOS circuit device to un-latch before power is reapplied thereto. A watchdog timer may be added for controlling the power switch, wherein if a reset signal is not received by the watchdog timer within a certain time the watchdog timer will turn off the power switch. The current measurement circuit, the comparator and the power switch may be fabricated on a semiconductor integrated circuit die. The semiconductor integrated circuit die may be enclosed in an integrated circuit package. The current measurement circuit, the comparator, the power switch and the watchdog timer may be fabricated on a semiconductor integrated circuit die. The semiconductor integrated circuit die may be enclosed in an integrated circuit package. A voltage regulator may be coupled to the current measurement circuit and the power switch. The voltage regulator may be a low dropout (LDO) voltage regulator. The current measurement circuit, the comparator, the power switch and the voltage regulator may be fabricated on a semiconductor integrated circuit die. The current measurement circuit, the comparator, the power switch, the watchdog timer and the voltage regulator may be fabricated on a semiconductor integrated circuit die.

According to another specific example embodiment of this disclosure, a digital system having automatic detection of CMOS circuit device latch-up and reset of power to unlatch the CMOS circuit device, said system may comprise: a current monitoring and protection circuit; a CMOS circuit device coupled to and powered from the current monitoring and protection circuit, wherein the digital device supplies a current trip point value to the current monitoring and protection circuit such that power is removed from the CMOS circuit device when current drawn by the CMOS circuit device is greater than the current trip point value. The current monitoring and protection circuit may comprise: a current measurement circuit having a measured current output; a comparator having a first input coupled to the measured current output of the current measurement circuit; a current trip set point circuit having a current trip set point output coupled to a second input of the comparator, wherein the current trip set point output is controlled by the current trip point value from the CMOS circuit device; and a power switch controlled by an output of the comparator, the power switch supplying the power to the CMOS circuit device, wherein the comparator compares the measured current from the current measurement circuit and the current trip set point output, whereby when the measured current is greater than the current trip set point output the power switch is turned off, and when the measured current is less than or equal to the current trip set point output the power switch is turned on. The current monitoring and protection circuit may receive power from a voltage regulator. The voltage regulator may be a low dropout (LDO) voltage regulator. A watchdog timer may control the power switch, wherein if a reset signal from the CMOS circuit device is not received by the watchdog timer within a certain time the watchdog timer will turn off the power switch. The power switch may stay off long enough for the CMOS circuit device to un-latch before the power is reapplied thereto. The current monitoring and protection circuit and the CMOS circuit device may be fabricated on a semiconductor integrated circuit die. The semiconductor integrated circuit die may be enclosed in an integrated circuit package. The current monitoring and protection circuit, the CMOS circuit device and the voltage regulator are fabricated on a semiconductor integrated circuit die. The semiconductor integrated circuit die may be enclosed in an integrated circuit package.

According to yet another specific example embodiment of this disclosure, a method of automatic detection of CMOS circuit device latch-up and reset of power to unlatch the CMOS circuit device, said method may comprise: monitoring current drawn by a CMOS circuit device; and comparing the current drawn by the CMOS circuit device to a current trip point wherein if the current drawn by the CMOS circuit device is greater than the current trip point then disconnecting power from the CMOS circuit device for a certain time. The method may further comprising the step of programming the current trip point. The step of programming the current trip point may be done by the CMOS circuit device. The method may further comprise the steps of: resetting a watchdog timer; and disconnecting power from the CMOS circuit device for the certain time if the watchdog timer is not reset. The certain time may be long enough for the CMOS circuit device to un-latch before power is reapplied thereto.

### BRIEF DESCRIPTION OF THE DRAWINGS

A more complete understanding of the present disclosure thereof may be acquired by referring to the following description taken in conjunction with the accompanying drawings wherein:

FIG. 1 illustrates a schematic block diagram of a monitoring and protection circuit, voltage regulator and digital processor, according to a specific example embodiment of the present disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

Referring now to the drawings, the details of specific example embodiments are schematically illustrated. Like elements in the drawings will be represented by like numbers, and similar elements will be represented by like numbers with a different lower case letter suffix.

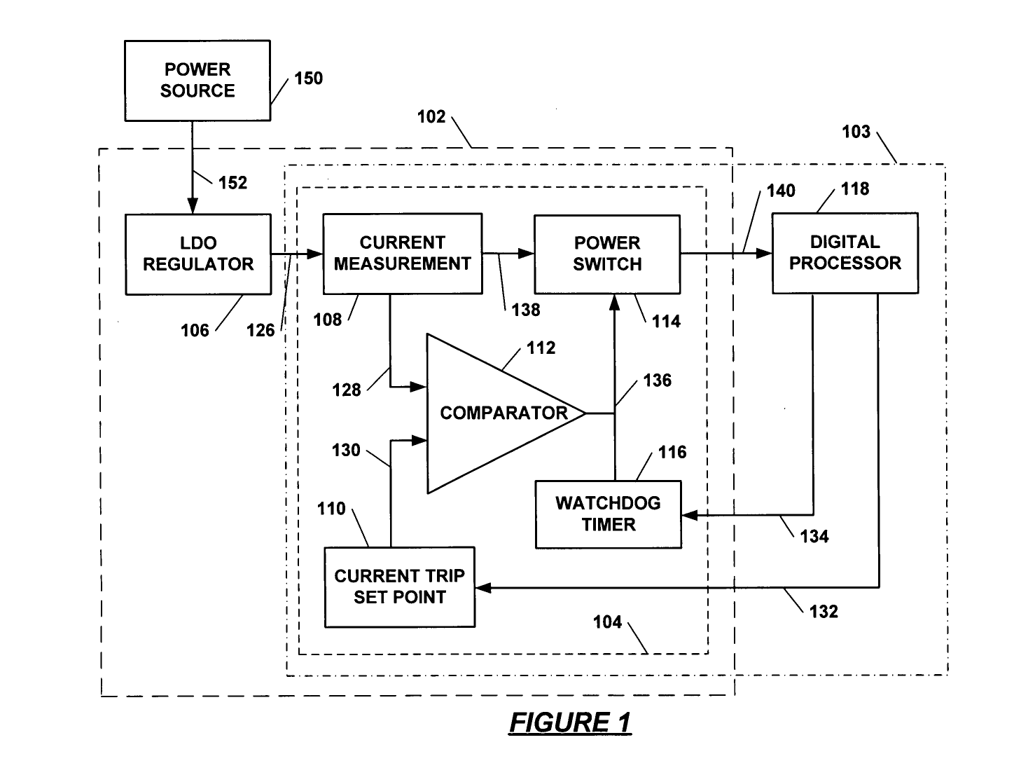

Referring to FIG. 1, depicted is a schematic block diagram of a monitoring and protection circuit, voltage regulator and digital processor, according to a specific example embodiment of the present disclosure. The monitoring and protection circuit, generally represented by the numeral 104, may comprise a current measurement circuit 108, a current trip set point circuit 110, a comparator 112 and a power switch 114. Optionally, a watchdog timer 116 may also control the power switch 114.

A voltage regulator 106, e.g., low drop-out voltage (LDO) regulator, may supply a desired voltage(s) to the monitoring and protection circuit 104. A power source 150 may supply voltage and current to the regulator 106. The regulator 106 may be fabricated with the monitoring and protection circuit 104 on an integrated circuit substrate, generally represented by the numeral 102.

A digital processor 118, e.g., microcomputer, microcontroller, digital signal processor (DSP), application specific integrated circuit (ASIC), programmable logic array (PLA) and the like, may receive power (e.g., voltage and current) from the monitoring and protection circuit 104, e.g., load side of the power switch 114. The digital processor 118 may have an output 132 that indicates an expected current draw so that the current trip set point circuit 110 may apply a current trip point 130 to an input of the comparator 112. The digital processor 118 may also have an output 134 that may be used to reset the watchdog timer 116. The output 132 may also be used to reset the watchdog timer 116 so that the output 134 may be eliminated. The monitoring and protection circuit 104 may be fabricated with the digital processor 118 on a single integrated circuit substrate, generally represented by the numeral 103. It is contemplated and with the scope of this disclosure that the monitoring and protection circuit 104, regulator 106 and/or digital processor 118 may be fabricated on at least one integrated circuit substrate packaged in an integrated circuit package (not shown).

Whenever the measured current 128 from the current measurement circuit 108 exceeds the current trip point 130, the comparator 112 uses control line 136 to open the power switch 114, thus removing power (voltage) from the digital processor 118. If the digital processor 118 CMOS circuits are in latch-up, then removing and reconnecting power may allow the CMOS circuits of the digital processor 118 to unlatch and begin proper operation again. The amount of time appropriate for clearing a latch-up condition (removal of power with the power switch 114) may be programmed into the monitoring and protection circuit 104.

In the event that the current drawn during latch-up of the digital processor 118 was not sufficient to exceed the value of the current trip point 130, then the watchdog timer 116 may control the power switch 114 if not timely reset by the digital processor 118. Thereby removing and reconnecting power to allow the CMOS circuits of the digital processor 118 to unlatch and begin proper operation again. Utilizing operation of the current sensing of the comparator 112 and the timeout of the watchdog timer 116, it may be possible to detect and recover from a latch-up condition in the shortest possible time.

It is contemplated and within the scope of this disclosure that the monitoring and protection circuit 104 may also be used as a solid state circuit breaker that may have at least one current trip value, and that at least one current trip value may be programmed during operation of the digital processor 118, or during system fabrication and/or start-up.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. An apparatus for monitoring and protection of a CMOS circuit device, comprising:
a current measurement circuit having a measured current output;
a comparator having a first input coupled to the measured current output of the current measurement circuit;
a current trip set point circuit having a current trip set point output coupled to a second input of the comparator; and
a power switch controlled by an output of the comparator,
wherein the comparator compares the measured current from the current measurement circuit and the current trip set point, whereby when the measured current is greater than the current trip set point the power switch is turned off, and when the measured current is less than or equal to the current trip set point the power switch is turned on.

2. The apparatus of claim 1, wherein the current trip set point is programmable.

3. The apparatus of claim 1, wherein the power switch is adapted for supplying power to a CMOS circuit device and the power switch stays off for a certain time before turning back on.

4. The apparatus of claim 3, wherein the certain time is long enough for the CMOS circuit device to un-latch before power is reapplied thereto.

5. The apparatus of claim 1, further comprising a watchdog timer controlling the power switch, wherein if a reset signal is not received by the watchdog timer within a certain time the watchdog timer will turn off the power switch.

6. The apparatus of claim 1, wherein the current measurement circuit, the comparator and the power switch are fabricated on a semiconductor integrated circuit die.

7. The apparatus of claim 6, wherein the semiconductor integrated circuit die is enclosed in an integrated circuit package.

8. The apparatus of claim 5, wherein the current measurement circuit, the comparator, the power switch and the watchdog timer are fabricated on a semiconductor integrated circuit die.

9. The apparatus of claim 8, wherein the semiconductor integrated circuit die is enclosed in an integrated circuit package.

10. The apparatus of claim 1, further comprising a voltage regulator coupled to the current measurement circuit and the power switch.

11. The apparatus of claim 1, wherein the voltage regulator is a low dropout (LDO) voltage regulator.

12. The apparatus of claim 10, wherein the current measurement circuit, the comparator, the power switch and the voltage regulator are fabricated on a semiconductor integrated circuit die.

13. The apparatus of claim 5, further comprising a voltage regulator coupled to the current measurement circuit and the power switch.

14. The apparatus of claim 13, wherein the current measurement circuit, the comparator, the power switch, the watchdog timer and the voltage regulator are fabricated on a semiconductor integrated circuit die.

15. The apparatus of claim 12, wherein the semiconductor integrated circuit die is enclosed in an integrated circuit package.

16. A digital system having automatic detection of CMOS circuit device latch-up and reset of power to unlatch the CMOS circuit device, said system comprising:
a current monitoring and protection circuit;
a CMOS circuit device coupled to and powered from the current monitoring and protection circuit, wherein the digital device supplies a current trip point value to the current monitoring and protection circuit such that power is removed from the CMOS circuit device when current drawn by the CMOS circuit device is greater than the current trip point value.

17. The digital system according to claim 16, wherein the current monitoring and protection circuit comprises:
a current measurement circuit having a measured current output;
a comparator having a first input coupled to the measured current output of the current measurement circuit;
a current trip set point circuit having a current trip set point output coupled to a second input of the comparator, wherein the current trip set point output is controlled by the current trip point value from the CMOS circuit device; and
a power switch controlled by an output of the comparator, the power switch supplying the power to the CMOS circuit device,
wherein the comparator compares the measured current from the current measurement circuit and the current trip set point output, whereby when the measured current is greater than the current trip set point output the power switch is turned off, and when the measured current is less than or equal to the current trip set point output the power switch is turned on.

18. The digital system according to claim 16, wherein the current monitoring and protection circuit receives power from a voltage regulator.

19. The digital system according to claim 18, wherein the voltage regulator is a low dropout (LDO) voltage regulator.

20. The digital system according to claim 16, wherein the CMOS circuit device is a digital processor.

21. The digital system according to claim 16, wherein the digital processor is a microcontroller.

22. The digital system according to claim 16, wherein the digital processor is a digital signal processor (DSP).

23. The digital system according to claim 16, wherein the digital processor is a microcomputer.

24. The digital system according to claim 16, wherein the digital processor is selected from the group consisting of an application specific integrated circuit (ASIC) and a programmable logic array (PLA).

25. The digital system according to claim 17, further comprising a watchdog timer controlling the power switch, wherein if a reset signal from the CMOS circuit device is not received by the watchdog timer within a certain time the watchdog timer will turn off the power switch.

26. The digital system according to claim 17, wherein the power switch stays off long enough for the CMOS circuit device to un-latch before the power is reapplied thereto.

27. The digital system according to claim 16, wherein the current monitoring and protection circuit and the CMOS circuit device are fabricated on a semiconductor integrated circuit die.

28. The digital system according to claim 27, wherein the semiconductor integrated circuit die is enclosed in an integrated circuit package.

29. The digital system according to claim 18, wherein the current monitoring and protection circuit, the CMOS circuit device and the voltage regulator are fabricated on a semiconductor integrated circuit die.

30. The digital system according to claim 29, wherein the semiconductor integrated circuit die is enclosed in an integrated circuit package.

31. A method of automatic detection of CMOS circuit device latch-up and reset of power to unlatch the CMOS circuit device, said method comprising:
monitoring current drawn by a CMOS circuit device; and
comparing the current drawn by the CMOS circuit device to a current trip point wherein if the current drawn by the CMOS circuit device is greater than the current trip point then disconnecting power from the CMOS circuit device for a certain time.

32. The method according to claim 31, further comprising the step of programming the current trip point.

33. The method according to claim 31, wherein the step of programming the current trip point is done by the CMOS circuit device.

34. The method according to claim 31, further comprising the steps of:
resetting a watchdog timer; and
disconnecting power from the CMOS circuit device for the certain time if the watchdog timer is not reset.

35. The method according to claim 31, wherein the certain time is long enough for the CMOS circuit device to un-latch before power is reapplied thereto.
